(19) United States
(12) Patent Application Publication
(10) Pub. No.: US 2013/0090137 A1
(43) Pub. Date: Apr. 11, 2013

(54) APPARATUS AND METHODS FOR REDUCING PAGE LOSS IN MULTIPLE SUBSCRIPTION, MULTIPLE RADIO ACCESS TECHNOLOGY DEVICES

(71) Applicants: Sathish Krishnamoorthy, Hyderabad (IN); Suresh Sanka, Hyderabad (IN); Ajit Gupta, Hyderabad (IN); Asimava Bera, Hyderabad (IN); Shivank Nayak, Hyderabad (IN); Uttam Pattanayak, Hyderabad (IN)

(72) Inventors: Sathish Krishnamoorthy, Hyderabad (IN); Suresh Sanka, Hyderabad (IN); Ajit Gupta, Hyderabad (IN); Asimava Bera, Hyderabad (IN); Shivank Nayak, Hyderabad (IN); Uttam Pattanayak, Hyderabad (IN)

(73) Assignee: QUALCOMM INCORPORATED, San Diego, CA (US)

(21) Appl. No.: 13/253,220

(22) Filed: Oct. 5, 2011

(51) Int. Cl. H04W 68/00

(52) U.S. Cl. 455/458

(57) ABSTRACT

Disclosed are methods and apparatus for reducing page loss in a multiple subscription, multiple radio access wireless device, such as a dual SIM wireless device. The disclosed methodology and apparatus determine whether a conflict will arise between paging channel information received from at least two or more subscriptions from two or more radio access networks using a single receiver in the wireless device. The reception for paging channel information via the wireless receiver is switched to receive the paging channel information from a neighboring cell for one of the two subscriptions when a conflict is determined. By switching reception of paging channel information to another neighboring cell, the likelihood of page collisions between two subscriptions is reduced.

### BACKGROUND

1. Field

The present disclosure relates generally to apparatus and methods for reducing page loss in multiple radio access technology devices, and more specifically to reducing page loss in multiple subscription devices utilizing a single receiver for receiving paging channel information for the multiple subscriptions.

2. Background

Increasingly, networks or systems supporting wireless communications for multiple subscriptions, such as multiple authorized accesses for a particular subscriber or wireless device to different carriers, networks, radio technologies, and so forth, and associated wireless devices or user equipment operable for such multiple subscriptions, are becoming more prevalent. Such systems and devices allow users, among other things, to switch between Service Providers to take advantage of the best deals, or allow users to use a single wireless device for multiple mobile numbers, such as for keeping personal and work calls and data separate.

Furthermore, in multiple subscription systems and devices, such as dual subscriber identity module (SIM) or dual subscription (DS) systems, as examples, a dual standby (also referred to as “DS”) can be supported on both subscriptions for multiple radio access technologies (RATs) or differing radio access networks (RANs) with a single radio frequency (RF) device (e.g., receiver modem in a wireless user equipment (UE)) by sharing the RF for page reception for both of the subscriptions from respective RATs or RANs. Typically, a UE is paged in a particular RAT at a predetermined periodicity particular to that RAT. The periodicity for page reception in each RAT is defined by a discontinuous reception (DRX) cycle length, which is used to conserve energy of the UE device. Thus, in a dual subscription or dual SIM device using dual standby (i.e., a DS/DS device), the different RATs will typically have respectively different periodicities or DRX cycles.

A drawback of such a scheme, however, is an increased potential for missed pages as conflicts may occur between the time lines of pages received from both subscriptions in a single RF modem. This is due to the fact that as different RATs usually will have different periodicities and DRX cycles that, furthermore, may be co-prime (i.e., having no common multiples of the period). For example, WCDMA and GSM paging cycles are never multiples of each other for all possible combinations of paging cycle durations. Due to this factor, and the due to the fact of sharing the RF in a DS/DS device, pages lost due to collision between the pages of two subscriptions becomes inevitable within the scope of wireless standards. Thus, there is a need in the art to reduce page loss in dual subscriber/dual identity module (SIM) devices utilizing dual standby (e.g., utilizing a single RF receiver) to receiving page information).

### SUMMARY

According to an aspect, a method for reducing page loss in paging channel information in a wireless device is disclosed. The method includes determining whether a conflict will arise between paging channel information received from at least two or more subscriptions from two or more radio access networks using a single receiver in the wireless device. Additionally, the method includes switching reception of paging channel information for one of the two or more subscriptions in the wireless device to a neighboring cell when a conflict is determined.

In another aspect, an apparatus for reducing page loss in a wireless device is disclosed. The apparatus includes means for determining whether a conflict will arise between paging channel information received from at least two or more subscriptions from two or more radio access networks using a single receiver in the wireless device. Furthermore, the device includes means for switching reception of paging channel information for one of the two or more subscriptions in the wireless device to a neighboring cell when a conflict is determined.

According to yet another aspect, an apparatus for reducing page loss in a wireless device is disclosed. The apparatus includes at least one processor configured to perform various processes or functions. In particular, the process is configured to determine whether a conflict will arise between paging channel information received from at least two or more subscriptions from two or more radio access networks using a single receiver in the wireless device. Additionally, the processor is also configured to switch reception of paging channel information for one of the two or more subscriptions in the wireless device to a neighboring cell when a conflict is determined.

According to still one more aspect, a computer program product comprising: computer-readable medium is disclosed. The computer-readable medium includes code for causing a computer to determine whether a conflict will arise between paging channel information received from at least two or more subscriptions from two or more radio access networks using a single receiver in a wireless device. Additionally, the medium includes code for causing a computer to switch reception of paging channel information for one of the two or more subscriptions in the wireless device to a neighboring cell when a conflict is determined.

### BRIEF DESCRIPTION OF THE DRAWINGS

FIG. 1 illustrates an example of an environment having multiple RATs, RANs, or Service Providers in which the present methods and apparatus are utilized

FIG. 2 is a timing diagram illustrating page collision between WCDMA and GSM paging channel information in a DS/DS single RF system.

FIG. 3 is a timing diagram illustrating an exemplary solution for preventing page collision between WCDMA and GSM paging channel information in a DS/DS single RF system.

FIG. 4 illustrates a method for reducing page loss in multiple radio access technology devices, such as DS/DS single RF devices.

FIG. 5 illustrates another method for reducing page loss in multiple radio access technology devices, such as DS/DS single RF devices.

FIG. 6 illustrates yet another method for reducing page loss in multiple radio access technology devices, such as DS/DS single RF devices.

FIG. 7 illustrates an apparatus operable for employing the presently disclosed methods for reducing page loss for a multiple radio access technology device.

FIG. 8 illustrates another apparatus operable for employing the presently disclosed methods for reducing page loss for a multiple radio access technology device.

### DETAILED DESCRIPTION

Multiple subscription systems with dual standby, such as the Dual Subscription/Dual Standby (DS/DS) single RF systems discussed above, afford cost minimization in terms of resources and hardware. A drawback of these types of shared systems, as also discussed above, is the increased potential for missed pages as conflict may occur between pages from each of the multiple subscriptions. The present disclosure advantageously recognizes that in most field environments there will be more than one suitable cell (e.g., base station or Node B) available to a user equipment (UE). Additionally, neighboring cells usually do not have the same timing for Paging channel information Channel (PICH) reception. The presently disclosed methods and apparatus utilize these recognitions and characteristics to afford prevention of missing pages in a DS/DS single RF system.

It is first noted here that the word “exemplary” is used herein to mean “serving as an example, instance, or illustration.” Any example or aspect described herein as “exemplary” is not necessarily to be construed as preferred or advantageous over other examples or aspects.

It is also noted that the techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. Further, the terms “service provider” or “carrier” may be synonymous with “network” in that a particular provider or carrier supplies the network. Additionally, the term “air-interface” is used to denote a radio technology. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2) and may include improvements such as Ultra Mobile Broadband (UMB). These various radio technologies and standards are known in the art. For clarity, certain aspects of the techniques are described below for GSM and WCDMA, and attendant terminology is used in much of the description below.

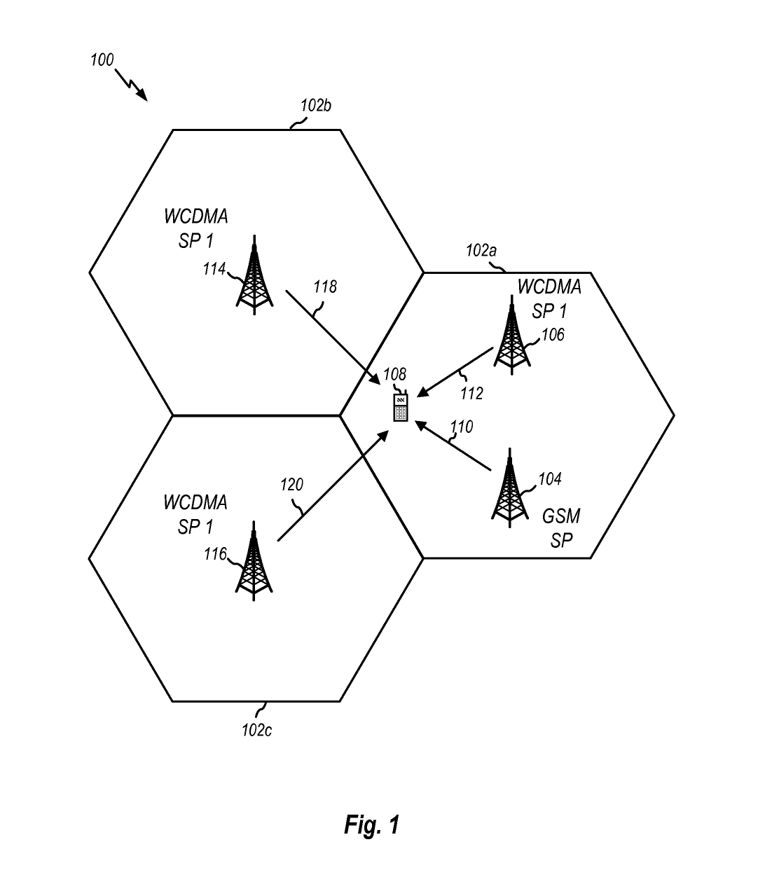

FIG. 1 illustrates an example of a location 100 having multiple RATs, RANs, or Service Providers in which the present methods and apparatus might be utilized. A first cell 102a is shown with a base station 104 effecting coverage for a first wireless RAN or RAT (e.g., a GSM service provider) and a base station 106 effecting coverage for a second wireless RAN or RAT (e.g., a WCDMA service provider). A dual subscription (DS)/dual standby (DS) mobile device or user equipment (UE) 108 may receive paging channel information via paging information channels (PICH) 110 and 112 from the respective base stations 104 and 106 and their respective RATs. In an aspect, a multiple subscription device (e.g., UE 108) will be camped on two or more serving base stations corresponding to the number of different subscriptions in the device. Thus, in the example of FIG. 1, if UE 108 is a dual subscription device having a GSM subscription and a WCDMA subscription, UE 108 may be camped on base station 104 for the GSM subscription and base station 106 for the WCDMA subscription.

Additionally, for purposes of illustrating the presently disclosed methods and apparatus, the UE 108 may be located such that other paging channels (e.g., 118, 120) may be received from a plurality of other neighboring cells 102b and 102c for at least one of RATs in the serving cell (i.e., cell 102a). In FIG. 1, cells 102b and 102c may include respective base stations 114 and 116 that effect coverage for at least one of the RATs. In the illustrated example, each respective base station 114, 116 provides WCDMA coverage for the same network or service provider (e.g., SP1) as base station 106. As discussed before, page loss may occur in a cell 102 when paging channel information from different RATs is received from base stations, such as 104 and 106, by UE 108 at the same time.

It is noted that device 108 may be any device, or portion thereof, that is capable of wirelessly connecting to a network via an air interface, such as GSM, UMTS, CDMA, LTE, Wi-Fi, WiMax, etc. Examples of such a device may include, but are not limited to, a user equipment (UE), mobile handset, a laptop/notebook computer, a netbook, a PDA, mobile terminal, access terminal, a virtual computer terminal, or a cell phone.

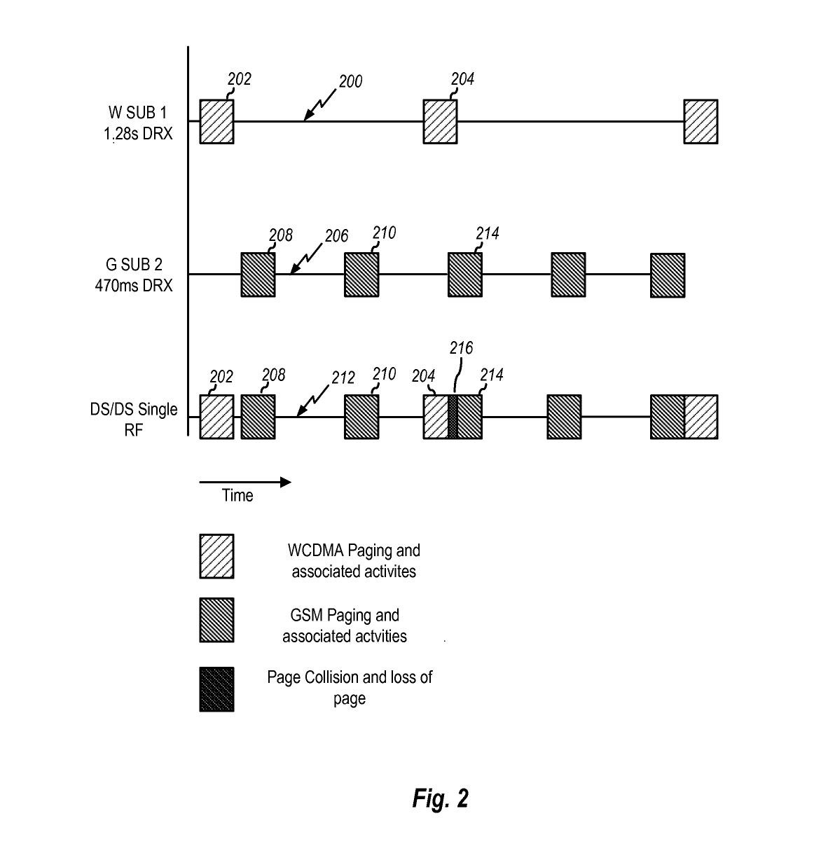

FIG. 2 is a timing diagram illustrating page collision between WCDMA and GSM paging information in a DS/DS single RF system, such as the system illustrated in FIG. 1. A timeline 200 illustrates paging and other associated activities from a serving WCDMA subscription (SUB 1), as one example. Timeline 200 is shown for a particular WCDMA standard wherein the DRX has a pitch or periodicity of 1.28 seconds between paging and associated activities, such as between pages 202 and 204. Similarly, another timeline 206 for a second subscription; namely a GSM subscription (SUB 2) having a DRX pitch or periodicity of 470 ms between paging and associated activities such as 208 and 210.

A combined DS/DS single RF timeline 212 illustrates the time relationship of timelines 200 and 206. As may be seen, WCDMA paging and associated activities 202 occurs, followed by GSM paging 208 received without conflict. Paging activity 210 from the GSM subscription occurs next, also without conflict. Next, however, the timelines 200 and 206 next have activity overlap causing a conflict between paging activities from the two subscriptions. As may be seen in FIG. 2, at least a portion of paging activity 204 overlaps in time with a portion of paging activity 214. Thus, a collision occurs between the two pages as illustrated by blackened area 216, which results in loss of at least one of the pages 204 and 214.

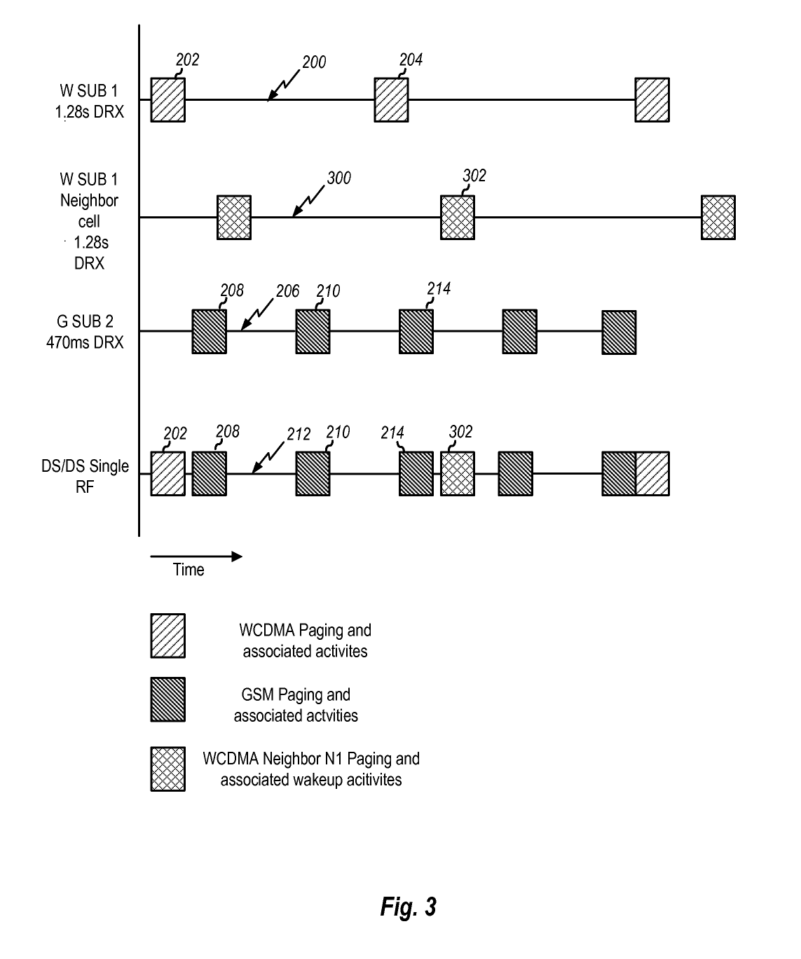

As a solution to the problem of FIG. 2, FIG. 3 shows a timing diagram illustrating an exemplary solution for preventing page collision between WCDMA and GSM paging information in a DS/DS single RF system. It is noted that the timelines 200 and 206 shown in FIG. 2 are the repeated in FIG. 3.

An exemplary solution to the collision between the paging activities 204 and 214 from timelines 200 and 206, respectively, include examining at least one other neighboring cell and temporarily selecting (or permanently reselecting) that cell as a source of paging information for at least one subscription. As mentioned before, other cells typically will not have a synchronous timeline with neighboring cells, but are offset from one another. As an illustration, FIG. 3 shows a timeline 300 of the paging information of the WCDMA subscription (SUB 1) from a neighboring cell (e.g., cell 102b or 102c in the example of FIG. 1) to the serving cell. Since the neighboring cell transmits the same or similar paging information, a UE may switch to receive that paging information in its RF from the neighboring cell for the paging information to avoid collision. Thus, rather than receiving paging information 204 from the receiving cell, which conflicts with paging information 214 from the GSM subscription, the UE may switch to the neighboring cell to receiving paging information 302.

DS/DS single RF timeline 212 illustrates this reselection or temporary selection in that the UE does not receive the paging information 204, but rather receives the SUB 1 subscription paging information 302 from the neighboring cell. This paging information 302, along with associated wakeup activities, occurs in time after paging information 214, thus avoiding conflict and page loss.

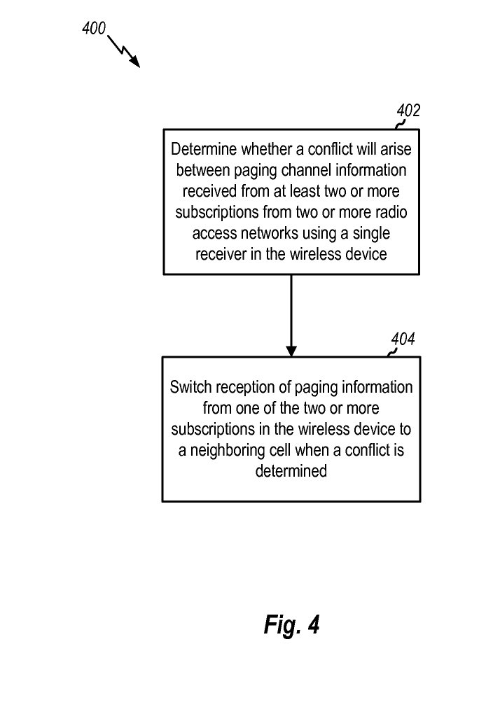

FIG. 4 illustrates a method 400 for reducing page loss in multiple radio access technology devices, such as DS/DS single RF devices. Method 400 includes determining whether a conflict will arise between paging channel information received from at least two or more subscriptions from two or more radio access networks using a single receiver in the wireless device as shown in block 402. This may be accomplished by comparing the DRX timelines of the two subscriptions, such as timelines 200 and 206, relative to each other and with knowledge of the paging periodicity. Accordingly, conflicts may be predicted. Further, this determination may be accomplished using hardware, software, firmware, or any combination thereof within a UE. As one example, a Digital Signal Processor (DSP) may be used to make this determination in combination with a single RF receive chain circuitry.

After the determination in block 402, method 400 includes in block 404 switching reception of paging information from one of the subscriptions in the wireless device to a neighboring cell when a conflict is determined, such as was illustrated in FIG. 2. This selection may be accomplished using hardware, software, firmware, or any combination thereof within a UE. As one example, a Digital Signal Processor (DSP) may be used to make this determination in combination with a single RF receive chain circuitry.

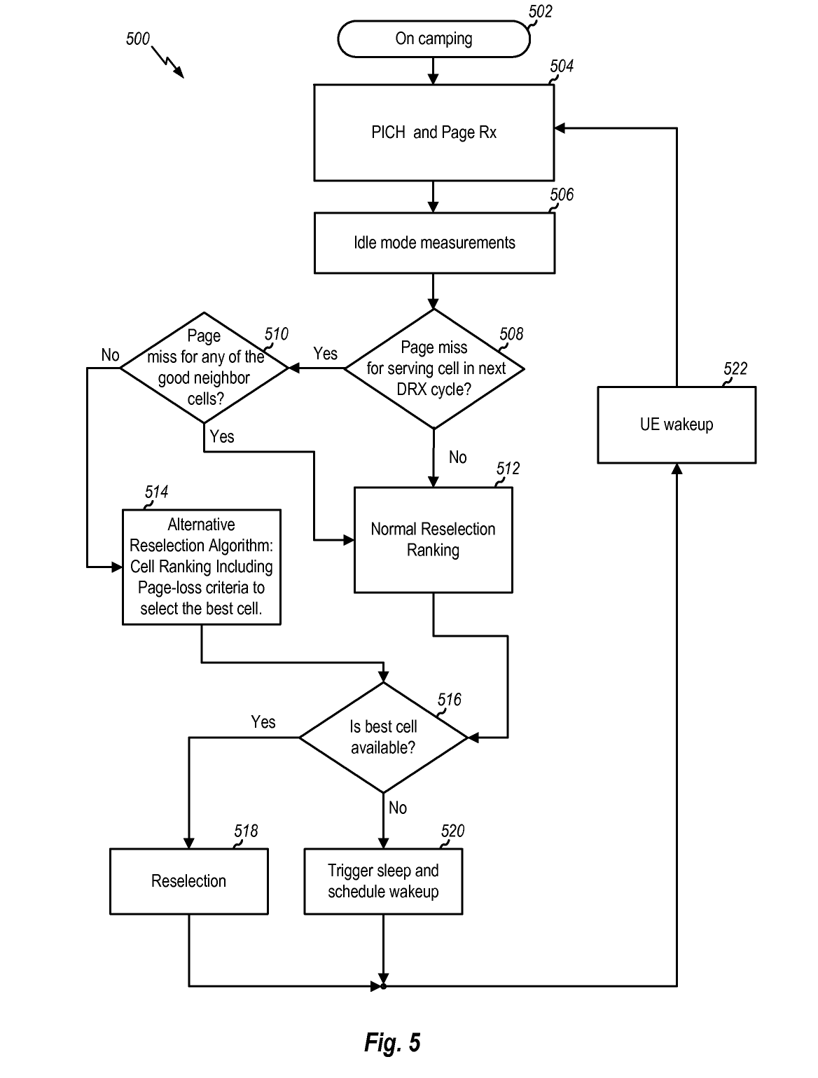

FIG. 5 illustrates another method 500 for reducing page loss in multiple radio access technology devices, such as DS/DS single RF devices. Method 500, in particular, includes reselection of a neighboring cell from which to receive paging channel information. In an aspect, the reselection methodology may be similar to reselection as specified in 3GPP Specification 25.304. The 3GPP standard specifies reselection as a means to shift to a best suitable neighbor cell.

As illustrated, method 500 begins with a UE, such as a DS/DS single RF UE, camping on a particular serving cell as indicated in block 502. In block 504, the UE receives the paging indicator channel (PICH) and paging information. After reception of the PICH and paging information, flow proceeds to block 506 where idle mode measurements are made. In an aspect, the idle mode measurements may include determination of the DRX timeline information for paging of two or more subscriptions in the serving cell, as well as determining neighboring cell information for establishing reselection ranking of neighboring cells, and, in an aspect, DRX information for the neighboring cells. According the example of FIG. 5, the measurements in block 506 are performed during idle mode of the UE when no active paging reception is being performed.

After measurement in block 506, flow proceeds to decision block 508 where a determination is made whether paging information will collide or be missed for reception from the serving cell during the next DRX cycles, the number of which is predefined according to what is most desirable or suitable threshold of page loss. If a page miss will occur, flow proceeds to decision block 510 where a determination is made whether a page miss will occur for any or all of the good neighbor cells (i.e., neighbor cells that are sufficient for reselection). Alternatively, at block 508, if no page miss will occur, flow proceeds to block 512 where the process includes maintaining reselection ranking according to a normal reselection ranking, such as reselection as specified in 3GPP Specification 25.304, as one example.

Concerning block 510, if it is determined that page miss will occur among the good neighbor cells, flow proceeds to block 512 for maintaining a normal reselection ranking. This decision is based on the fact if a page miss or conflict will occur among even good neighbor cells, a miss is inevitable and normal reselection is sufficient. However, if no page miss will occur among none or at least one of the good neighbor cells, flow proceeds to block 514 where an alternative reselection algorithm for cell ranking may be executed. In an aspect, the algorithm may include page-loss criteria to select the best cell among neighboring cells to minimize the likelihood of page loss, as well as rank further neighboring cells.

From either block 512 or 514, flow proceeds to determination block 516 to determine if a best cell according to either the normal reselection ranking (as in the case of flow proceeding from block 512) or the alternate reselection ranking (as in the case of flow proceeding from block 514). In either case, the process of block 516 is a determination of whether the best cell is available from a particular ranking, and if it is, flow proceeds to block 518 where reselection is effected. If a best cell is not available, the method 500 proceeds to block 520 wherein a device sleep mode is triggered and a next wakeup of the UE device is scheduled. It is noted that after reselection in block 518 or the process of block 520, flow proceeds to block 522 where the UE is awoken and flow proceeds back to the paging channel reception. Of course, in the case of reselection, conflicts in some of the paging information for at least one of the subscriptions will be avoided due to the reselection.

According to an aspect, method 500, and the process of block 514, in particular, could present an extension of the 3GPP rule by including the chances of avoiding collision as an additional criterion for reselection (i.e., an alternate reselection ranking algorithm). In particular, an exemplary algorithm is contemplated by adding additional criterion to the criterion of the 3GPP Specification 25.304 as described in the description following.

First, in terms of defining algorithm variables in the following discussion of an exemplary alternate cell reselection algorithm, S1 denotes a serving cell (e.g., 102a in FIG. 1); Nn (e.g., N1, N2, N3, etc.) denotes exemplary neighbor cells (e.g., 102b and 102c in FIG. 1); S(Cell) denotes suitability criterion as per 3GPP spec 25.304; P(Cell, M) denotes the probability of a page collision with the other subscription for a ‘Cell’ after M number of DRX cycles; A(Cell) denotes additional suitability criterion; and Threshol_{spc} denotes a threshold for switching to an alternative cell reselection algorithm.

In accordance with the 3GPP specification, cells are considered for ranking only if the suitability criterion for each neighbor cell meets the condition of S(Nx)>0. Thus, before ranking the cell based on suitability criterion S, the additional suitability criterion A(Cell) may be performed to determine the probability of page collision at the serving cell S1 over M DRX cycles as represented by the relationship A(S1)=P(S1,1)+ . . . +P(S1, M). After the determination of the additional suitability criterion A(Cell), if A(S1) is less than the Threshol_{spc}, then the algorithm may proceed to consider an “Alternative Reselection” algorithm. Otherwise, the algorithm may continue with a regular reselection algorithm, such as that specified in 3GPP Specification 25.304. It is noted here that in method 500, this additional suitability determination may be implemented as part of the process 508, whether looking at merely one DRX cycle as illustrated in process 508, or modified to consider a multiple M number of DRX cycles.

If consideration of the “Alternative Reselection” algorithm is indicated, a determination of the additional suitability A for all the neighbor cells Nn as defined by A(Nn)=P(Nn, 1)+ . . . +P(Nn, M), as one example. For all neighbor cells, if A(Nn)>A(S1) for any of the neighbor cells, then the algorithm decides to consider the alternative reselection algorithm. Otherwise, the algorithm continues with the regular reselection algorithm. In the case where the alternative reselection algorithm is chosen, the algorithm may then further trigger reselection to the neighbor cell Nn having the highest A(Nn).

It is further noted that the algorithm described above can be incorporated into or clubbed together with an existing reselection algorithm to have a combined reselection threshold to prevent reselections to short-lived cells. In one example, a method would be to trigger reselection only if the cell also has S>1 for its Tresel timer (i.e., timer for timing reselection). Additionally, in another aspect in the case of a reselection triggered under normal circumstances, if there is a higher probability of page loss on the target neighbor cell, reselection could either be avoided or the UE could be configured to reselect to the best cell for which the probability of page loss is also low. It is yet further noted that in an aspect the alternative reselection algorithm can be deployed independently for both the subscriptions in a dual subscription device.

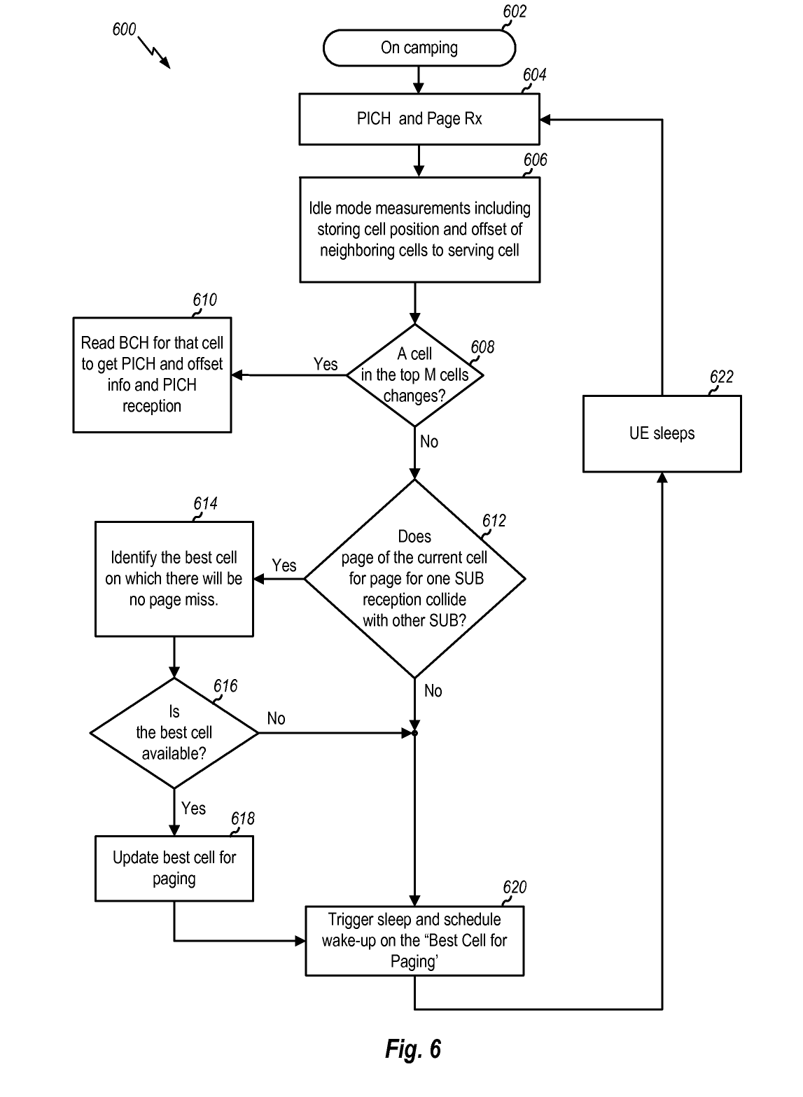

FIG. 6 illustrates another method 600 for reducing page loss in multiple radio access technology devices, such as DS/DS single RF devices. In this example, rather than performing reselection to a neighbor cell for receiving paging information, a UE may temporarily switch reception of pages for at least one subscription from neighboring cells having sufficient signal strength. In a typical system, a UE listens to page of a single cell. However, a network pages the UE in the entire location area, which may typically include several cells. Furthermore, many locations will usually have reception capability from many cells. Accordingly, these typical characteristics may be advantageously used to prevent page loss while only temporarily switching to other cells for paging information to avoid page collisions.

As illustrated, method 600 begins with a UE, such as a DS/DS single RF UE, camping on a particular serving cell as indicated in block 602. In block 604, the UE receives the paging indicator channel (PICH) and paging information. After the current reception of the PICH and page information in block 604, flow proceeds to block 606 where idle mode measurements are made. In an aspect, the idle mode measurements may include determination of the DRX timeline information for paging of two or more subscriptions in the serving cell, as well storing the cell position, and determining the DRX timing offset of neighboring cells relative to the serving cell. According to the example of FIG. 5, the measurements in block 606 are performed during idle mode of the UE when no active paging reception is being performed. In the present example, a list of the top M neighbor cells based on the idle mode measurements may also be determined. In particular, a UE may be configured to keep track of the cell position and paging time for up to M strong neighbors having a particular degree of suitability (e.g., a suitability factor S>0 or a value based on an absolute measured value like the received signal strength indicator (RSSI) or the ratio of received pilot energy, Ec, to total received energy or the total power spectral density, Io (Ec/To).

After block 606, flow proceeds to decision block 608 where a determination is made whether a cell in the top M cells changes. If so, flow proceeds to block 610 where the broadcast channels (BCH) for that cell are read to get the PICH and offset information of the PICH and PICH reception. After the process in block 610, flow may continue back to block 604 (not shown) or to a sleep mode (e.g., block 622 to be discussed below). In the alternative, if a change in the top M cells has not occurred as determined in block 608, flow proceeds to decision block 612 for determination of whether a page of a current cell for page reception of a subscription will collide with a page from the other subscription. If not, then no change needs to be made to the current cell from which to receive paging information and flow may proceed to block 620, to be discussed later.

In the alternative, if the answer to the determination of block 612 is yes, flow proceeds to block 614 where the UE may identify the best cell for which there will be no page miss. Next, a determination is then made to ensure that the identified best cell is currently available as shown in block 616. If not, flow proceeds to block 620. If the best cell is available, the best cell is selected to receive paging information from that cell for at least one of the subscriptions (e.g., a WCDMA subscription). After the update in block 618, flow proceeds to block 620 where a sleep mode is triggered and the wake-up for the UE is scheduled based on the timing of the updated best cell for paging. After the triggering of sleep and wakeup scheduling the UE sleeps, as indicated in block 622, until wakeup when a next PICH and page reception is performed at block 604.

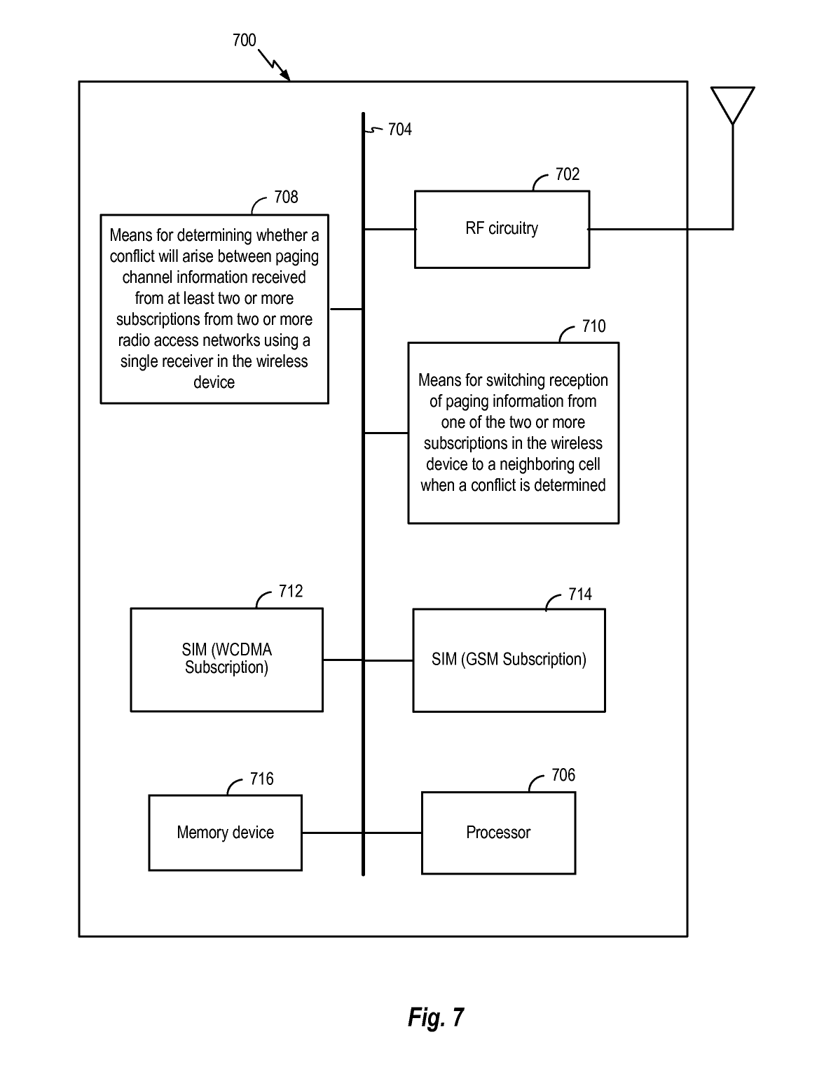

The above-disclosed algorithms may be implemented in a UE or similar device. As an example, FIG. 7 illustrates a device or apparatus 700 operable for employing the presently disclosed methods for reducing page loss for a multiple radio access technology device. The apparatus 700 is operable within a UE or other wireless device. As illustrated, the apparatus 700, which may be configured as a UE, may include an RF circuitry 702 that is configured to receive signals via one or more air interfaces. In one example, the RF circuitry 702 may be configured to receive signals via the dual air interfaces, such as a WCDMA subscription and a GSM subscription, as one example. It is noted here that a communication bus 704 is illustrated in the example of FIG. 7 merely to indicate that blocks, modules, or circuitry within device 700 are communicatively coupled to afford communication of data and information there between. It is also noted that the various blocks, modules, and circuitry may be incorporated into a single platform or chip, or separately in various degrees as illustrated in FIG. 7.

Device 700 also includes a digital signal processor (DSP) (shown as processor 706) or equivalent apparatus to process signals received by the RF circuitry 702, such as when receiving paging channel information from one or more air interfaces. Additionally, RF circuitry 702 and processor 706 may comprise a modem effecting a DS/DS device that is used for transmitting/receiving and processing signals once the device is connected to one or more subscriber networks.

Device 700 also includes a means or module 708 for determining whether a conflict will arise between paging channel information received from at least two or more subscriptions from two or more radio access networks using a single receiver in the wireless device, such as paging information from a GSM subscription and a WCDMA subscription. It is noted that means 708 may be implemented with hardware, software, firmware, or any combination thereof, and may further be implemented separately as shown, or alternatively may be implemented by RF circuitry 702 and processor 706.

Additionally, device 700 includes a means or module 710 for switching reception of paging information from one of the two subscriptions in the wireless device to a neighboring cell when a conflict is determined. It is noted that means 710 may be implemented with hardware, software, firmware, or any combination thereof, and may further be implemented separately as shown, or alternatively be implemented by RF circuitry 702 and processor 706.

In the case a dual or multi-subscription device, apparatus 700 may include SIM modules 712 and 714. In the illustrated example, a SIM 712 (or equivalent functionality) for a WCDMA subscription and a SIM 714 for a GSM subscription are shown, but not limited to such technologies or number of subscriptions. Also included is a memory device 716 used to store instructions executable by the processor 708 to implement paging information reception and other functions.

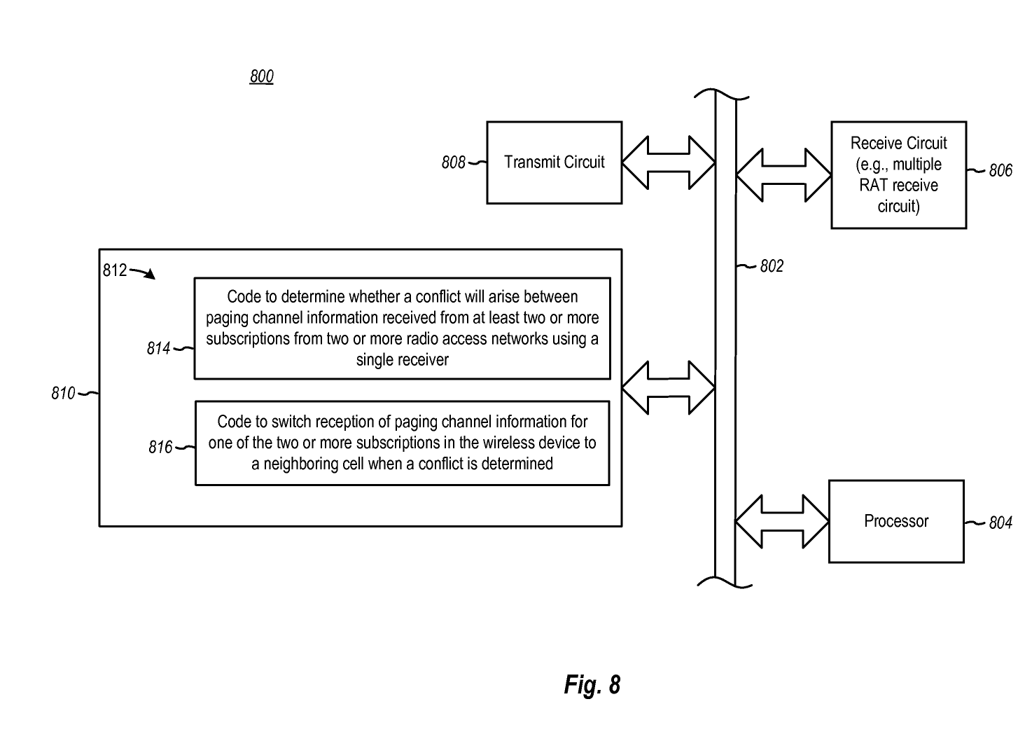

FIG. 8 shows part of a hardware implementation of an apparatus 800 that is configured to reduce page loss for a multiple radio access technology device. The circuit apparatus is signified by the reference numeral 800, which includes circuitry and may be one configuration of a transceiver or mobile station modem. In this application, it should be clear that the terms “circuit” and “circuitry” are to be construed as structural terms and not as functional terms. For example, circuitry can be an aggregate of circuit components, such as a multiplicity of integrated circuit components, in the form of processing and/or memory cells, units, blocks and the like, such as shown and described in FIG. 8.

The apparatus 800 comprises a central data bus 802 linking several circuits together. The circuits include a processor 804, a receive circuit 806, which may be a receiver configured to receive at least page information for multiple subscriptions, a transmit circuit 808, and a memory 810. The memory 810 is in electronic communication with the processor 804, i.e., the processor 804 can read information from and/or write information to the memory 810.

The processor 804 may be a general purpose processor, a central processing unit (CPU), a microprocessor, a digital signal processor (DSP), a controller, a microcontroller, a state machine, an application specific integrated circuit (ASIC), a programmable logic device (PLD), a field programmable gate array (FPGA), etc. The processor 804 may include a combination of processing devices, e.g., a combination of a DSP and a microprocessor, a plurality of microprocessors, one or more microprocessors in conjunction with a DSP core, or any other such configuration.

The receive circuit 806 and the transmit circuit 808 can be connected to or part of an RF (Radio Frequency) circuit, which is not explicitly delineated in FIG. 8. The receive circuit 806 may process and buffer received signals before sending the signals out to the data bus 802. Additionally, the transmit circuit 808 may process and buffer the data from the data bus 802 before sending the data out of the device 800. The processor 804 may perform the function of data management of the data bus 802 and further the function of general data processing, including executing the instructional contents of the memory 810. Instead of separately disposed as shown in FIG. 8, as an alternative, the transmit circuit 808 and the receive circuit 806 may be part of the processor 804.

The memory 810 includes a set of instructions generally signified by the reference numeral 812. The instructions 812 may be executable by the processor 804 to implement the methods described herein, such as the methods of FIG. 4-6 for example. The instructions 812 may include code 814 for determining whether a conflict will arise between paging channel information received from at least two or more subscriptions from two or more radio access networks using a single receiver in a wireless device. The instructions 812 may also include code 816 for code for switching reception of paging channel information for one of the two or more subscriptions in the wireless device to a neighboring cell when a conflict is determined.

The instructions 812 shown in the memory 810 may comprise any type of computer-readable statement(s). For example, the instructions 812 in the memory 810 may refer to one or more programs, routines, sub-routines, modules, functions, procedures, data sets, etc. The instructions 812 may comprise a single computer-readable statement or multiple computer-readable statements.

The memory 810 may be a RAM (Random Access Memory) circuit. The memory 810 can be tied to another memory circuit (not shown) which can either be of the volatile or nonvolatile type. As an alternative, the memory 810 can be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art. The memory 810 may be considered to be an example of a computer-program product that comprises a computer-readable medium with instructions 812 stored therein.

In light of the foregoing description, one skilled in the art will appreciate that the present methods and apparatus afford the avoidance or minimization of the collision of paging channel information in a multi-subscription, dual standby UE or system (e.g., a DS/DS single RF system). This allows the cost of a UE, in particular, to remain lower by still using a single RF, but with increased performance due to minimization of page loss.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, means, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, means, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The above description of the disclosed examples is provided to enable any person skilled in the art to make or use the presently disclosed methods and apparatus. Various modifications to these examples will be readily apparent to those skilled in the art, and the generic principles defined herein may be applied to other examples without departing from the spirit or scope of the present disclosure. Thus, the present disclosure is not intended to be limited to the examples shown herein but is to be accorded the widest scope consistent with the principles and novel features disclosed herein.

What is claimed is:

1. A method for reducing page loss in paging channel information in a wireless device, the method comprising:
determining whether a conflict will arise between paging channel information received from at least two or more subscriptions from two or more radio access networks using a single receiver in the wireless device; and
switching reception of paging channel information for one of the two or more subscriptions in the wireless device to a neighboring cell when a conflict is determined.

2. The method as defined in claim 1, further comprising:
determining information concerning one or more neighboring cells serving at least one of the two or more radio access networks; and
determining a suitability of receiving paging channel information from the one or more neighboring cells prior to switching reception for paging channel information to the neighboring cell, wherein the neighboring cell is included in the one or more neighboring cells.

3. The method as defined in claim 2, wherein determining information concerning one or more neighboring cells includes idle mode measurements performed when the wireless device is in an idle mode.

4. The method as defined in claim 3, wherein the idle mode measurements include one or more of determining DRX timeline information for paging channel information of two or more subscriptions in the serving cell, determining neighboring cell information for establishing reselection ranking of neighboring cells, determining neighboring cells position; and determining offsets of neighboring cells to a current serving cell.

5. The method as defined in claim 1, wherein switching reception of paging channel information includes reselection of a neighboring cell from which to receive paging channel information according to a predetermined criterion.

6. The method as defined in claim 5, wherein the predetermined criterion includes criterion for cell reselection as set forth in 3GPP Specification 25.304.

7. The method as defined in claim 1, wherein switching reception includes temporarily switching reception to the neighboring cell, which is a cell determined as best suited from which to receive at least a next paging channel information.

8. The method as defined in claim 1, wherein the wireless device comprises a multi-subscription, multi-standby device configured to at least receive paging channel information from two or more radio access technologies.

9. The method as defined in claim 8, wherein the radio access technologies include CDMA, WCDMA, LTE and GSM technologies.

10. An apparatus for reducing page loss in a wireless device comprising:
means for determining whether a conflict will arise between paging channel information received from at least two or more subscriptions from two or more radio access networks using a single receiver in the wireless device; and
means for switching reception of paging channel information for one of the two or more subscriptions in the wireless device to a neighboring cell when a conflict is determined.

11. The apparatus as defined in claim 10, further comprising:
means for determining information concerning one or more neighboring cells serving at least one of the two or more radio access networks; and
means for determining a suitability of receiving paging channel information from the one or more neighboring cells prior to switching reception for paging channel information to the neighboring cell, wherein the neighboring cell is included in the one or more neighboring cells.

12. The apparatus as defined in claim 11, wherein the means for determining information concerning one or more neighboring cells includes means for idle mode measurements performed when the wireless device is in an idle mode.

13. The apparatus as defined in claim 12, wherein the means for idle mode measurements includes one or more of means for determining DRX timeline information for paging channel information of two or more subscriptions in the serving cell, means for determining neighboring cell information for establishing reselection ranking of neighboring cells, means for determining neighboring cells position; and means for determining offsets of neighboring cells to a current serving cell.

14. The apparatus as defined in claim 10, wherein the means for switching reception of paging channel information includes means for reselection of a neighboring cell from which to receive paging channel information according to a predetermined criterion.

15. The apparatus as defined in claim 14, wherein the predetermined criterion includes criterion for cell reselection as set forth in 3GPP Specification 25.304.

16. The apparatus as defined in claim 10, wherein the mean for switching reception includes means for temporarily switching reception to the neighboring cell, which is a cell determined as best suited from which to receive at least a next paging channel information.

17. The apparatus as defined in claim 10, wherein the wireless device comprises a multi-subscription, multi-standby device configured to at least receive paging channel information from two or more radio access technologies.

18. The apparatus as defined in claim 17, wherein the radio access technologies include CDMA, WCDMA, LTE and GSM technologies.

19. An apparatus for reducing page loss in a wireless device, the apparatus comprising at least one processor configured to:
determine whether a conflict will arise between paging channel information received from at least two or more subscriptions from two or more radio access networks using a single receiver in the wireless device; and
switch reception of paging channel information for one of the two or more subscriptions in the wireless device to a neighboring cell when a conflict is determined.

20. The apparatus as defined in claim 19, the at least one processor further configured to:
determine information concerning one or more neighboring cells serving at least one of the two or more radio access networks; and
determine suitability of receiving paging channel information from the one or more neighboring cells prior to switching reception for paging channel information to the neighboring cell, wherein the neighboring cell is included in the one or more neighboring cells.

21. The apparatus as defined in claim 20, wherein determining information concerning one or more neighboring cells includes idle mode measurements performed when the wireless device is in an idle mode.

22. The apparatus as defined in claim 21, wherein the idle mode measurements include one or more of determining DRX timeline information for paging channel information of two or more subscriptions in the serving cell, determining neighboring cell information for establishing reselection ranking of neighboring cells, determining neighboring cells position; and determining offsets of neighboring cells to a current serving cell.

23. The apparatus as defined in claim 19, wherein switching reception of paging channel information includes reselection of a neighboring cell from which to receive paging channel information according to a predetermined criterion.

24. The apparatus as defined in claim 23, wherein the predetermined criterion includes criterion for cell reselection as set forth in 3GPP Specification 25.304.

25. The apparatus as defined in claim 19, wherein switching reception includes temporarily switching reception to the neighboring cell, which is a cell determined as best suited from which to receive at least a next paging channel information.

26. The apparatus as defined in claim 19, wherein the wireless device comprises a multi-subscription, multi-standby device configured to at least receive paging channel information from two or more radio access technologies.

27. The apparatus as defined in claim 26, wherein the radio access technologies include CDMA, WCDMA, LTE and GSM technologies.

28. A computer program product, comprising:
computer-readable medium comprising:
code for causing a computer to determine whether a conflict will arise between paging channel information received from at least two or more subscriptions from two or more radio access networks using a single receiver in a wireless device; and
code for causing a computer to switch reception of paging channel information for one of the two or more subscriptions in the wireless device to a neighboring cell when a conflict is determined.

29. The computer program product as defined in claim 28, the computer-readable medium further comprising:
code for causing a computer to determine information concerning one or more neighboring cells serving at least one of the two or more radio access networks; and
code for causing a computer to determine suitability of receiving paging channel information from the one or more neighboring cells prior to switching reception for paging channel information to the neighboring cell, wherein the neighboring cell is included in the one or more neighboring cells.

30. The computer program product as defined in claim 29, wherein the code for causing a computer to determine information concerning one or more neighboring cells includes code for causing a computer to perform idle mode measurements when the wireless device is in an idle mode.

31. The computer program product as defined in claim 30, wherein the code for causing a computer to perform idle mode measurements include code for causing a computer to one or more of determine DRX timeline information for paging channel information of two or more subscriptions in the serving cell, determine neighboring cell information for establishing reselection ranking of neighboring cells, determine neighboring cells position; and determine offsets of neighboring cells to a current serving cell.

32. The computer program product as defined in claim 28, wherein the code for causing a computer to switch reception of paging channel information includes code for causing a computer to reselect a neighboring cell from which to receive paging channel information according to a predetermined criterion.

33. The computer program product as defined in claim 32, wherein the predetermined criterion includes criterion for cell reselection as set forth in 3GPP Specification 25.304.

34. The computer program product as defined in claim 28, wherein code for causing a computer to switch reception includes code for causing a computer to temporarily switch reception to the neighboring cell, which is a cell determined as best suited from which to receive at least a next paging channel information.

35. The computer program product as defined in claim 28, wherein the wireless device comprises a multi-subscription, multi-standby device configured to at least receive paging channel information from two or more radio access technologies.

36. The computer program product as defined in claim 35, wherein the radio access technologies include CDMA, WCDMA, LTE and GSM technologies.
